(19) United States
(12) Patent Application Publication
(10) Pub. No.: US 2002/0180771 A1
(43) Pub. Date: Dec. 5, 2002

(54) System and method for controlling data in a virtual being database

(76) Inventor: Shaw-Yueh Lin, San Diego, CA (US)

Correspondence Address: DANIEL ROBBINS, 3346A INDUSTRIAL COURT, SAN DIEGO, CA, 92121, US

(21) Appl. No.: 10/149,496

(22) PCT Filed: Dec. 13, 2000
(86) PCT No.: PCT/US00/33722

(51) Int. Cl. G09G 5/00; G06F 17/00

(52) U.S. Cl. 345/700; 707/100

(57) ABSTRACT

A virtual being database (154) made up of a set of hierarchically-arranged fields, wherein each field is tagged with access control information (152) controlling which parties (or computers) (110, 112, 114 and 116) are allowed to access each field, and which parties (or computers) (110, 112, 114 and 116) are allowed to revise each field. Some fields of the virtual being relate to personality traits (162), while other fields relate to body measurements. Also, data requests to be made by a plurality of virtual beings (154) to a remote networked computer (102) are aggregated into a single request in order to improve communication efficiency.

The present invention is directed to virtual being databases, and more particularly to ways in which data is structured, stored and revised in a virtual being database.

### BACKGROUND OF THE INVENTION

Building a fictional human character based on ascribing various numerical quantities and/or qualitative information in various fields in a database dates back at least as far as the game Dungeons and Dragons. For example, in Dungeons and Dragons, and other fantasy role-playing games, physical qualities such as strength, and less tangible qualities, such as courage, are ascribed numerical quantities (e.g., by rolling dice). (It is noted that the phrase Dungeons and Dragons may be subject to trademark rights.)

With the development of more sophisticated computers and more sophisticated computer networks, fictional characters have been stored and manipulated on computers and computer networks. In the computer world, fictional characters may be more aptly described as virtual beings (hereinafter “VB”).

For example, U.S. Pat. No. 5,884,029 (“Brush, II, et al.”—hereby incorporated by reference) discloses an “intelligent virtual object” (that is, a VB) for computer implementation that allows the virtual object to react to stimuli without the need to communicate each stimulus to a user (e.g., a human being who ultimately controls the intelligent virtual object). The VB of Brush, II, et al., is considered to be a representation of the user. The VB of Brush, II, et al. can be communicated around a computer network, such as the Internet, to perform tasks for the user, such as shopping for products that the user may potentially want to purchase. Brush, II, et al. does not disclose specifically how its VB is implemented, so it is somewhat difficult to determine whether a VB according to Brush, II, et al., could actually be made or used in practice.

An “intelligent agent” (“IA”) is disclosed in U.S. Pat. No. 6,088,731 (“Kiraly, et al.—hereby incorporated by reference). The IA of Kiraly, et al. has a synthetic personality and is disclosed to automatically and constantly communicate with authorized Internet sites in order to collect information believed to be of interest to some predetermined party (again called the “user”). The IA of Kiraly, et al. is disclosed to: (1) incorporate core technologies of artificial intelligence; (2) exhibit human intelligence and behavior; (3) recognize voices; (4) learn or adapt through experience; (5) follow policies; (6) mine for data; (7) recognize patterns; (8) understand natural language; (9) carry out its actions with a certain level of autonomy (based on programmed skills, knowledge bases, goals, models and skills learned through experience).

The IA of Kiraly, et al. is disclosed to be implemented by plug-in technology. More particularly, plug-in software is first downloaded to a user's computer. When the user downloads a web page from a computer network which includes reference (called a “tag”) to a presentation that is to make use of the plug-in software on the user's computer, the tag will automatically activate the plug-in software on the user's computer to execute the plug-in. When the plug-in is executed, it utilizes data present in the tag of the downloaded webpage as input data for the plug-in presentation.

According to the system of Kiraly, et al., The IA plug-in is present on a user's computer. If the user downloads a web page that has a special tag for the IA plug-in, then the IA will function using data from the tag as input data. In this sense, the system of Kiraly, et al. is a one way system only. The IA plug-in always remains at the user's computer. This may also limit the ways in which a server computer, remote from the user's IA plug-in computer, can interact with the server computer.

To the extent that specific publications are discussed above, these discussions should not be taken as an admission that the discussed publications are sufficiently enabling so as to amount to prior art for patent law purposes. Also, any specific publications discussed above are not admitted to be sufficiently early in time to be prior art, unless required by applicable patent law.

### SUMMARY OF THE INVENTION

The present application deals with: (1) a VB having both a personality and body measurements; (2) implementation of a VB by use of a hierarchical database with access control tags; and (3) improved methods of interaction between the VB and networked computers that are remote from the VB.

Generally speaking, VBs according to the present invention are implemented by a database including many fields, arranged in a hierarchy. Some fields may correspond to body measurements. For example, the body measurements may correspond to the actual physical body of some predetermined user. For example, if the user is a human being, then the VB may serve as an alter-ego for the human user by adjusting the body measurement fields to mimic those of the user, preferably on an ongoing basis over time. Other fields may correspond to personality traits. Again, these may or may not be set to emulate the personality of a corresponding human being. For example, a user may define a multitude of VB “employees” with differing personalities and characteristics so that employees can be selected for tasks based on their aptitudes and personalities.

At least some embodiments of the present invention may exhibit one or more of the following objects, advantages and benefits:

(1) a virtual being database (“VBD”) wherein some or all of the constituent data fields are associated with access control data (herein called “access control tags”—not to be confused with HTML tags in a web page) so the identity of the entities who can access (or not access) or revise information in the various fields of the VB can be controlled in a more refined manner;

(2) a VBD where the access control tags can allow certain, presumably trusted parties, to add to or revise data in the VBD;

(3) a VBD wherein trusted computers (and only trusted computers), remote from the database of the VB resides, can add or revise data to the VBD;

(4) a VB data wherein access control is effected on a field-by-field basis, rather than for the VBD as a whole;

(5) a VB that has both body and personality; and

(6) a method of using a virtual database wherein improved efficiency of communication is realized by aggregating requests among a group of VBs, so that a single aggregated request can be sent to a remote computer.

According to one aspect of the present invention, a virtual being database includes characteristic fields and access control data. The characteristic fields respectively define at least one characteristic of the virtual being. The access control data controls the level of access to the virtual being data, and thereby controls what entities can see or change the virtual being data. Preferably, different types of access, such as read-only access versus editing access, are separately controlled so that some entities have read-only access, but not editing access. Also, the access data is preferably arranged on a field-by-field basis with respect to the characteristic fields of the virtual being database, so that each field can have its own level of security and access control, depending upon the nature and sensitivity of the particular characteristic.

According to a further aspect of the present invention, a virtual being database includes body measurement characteristic fields and personality characteristic fields. The body measurement characteristic fields respectively define at least one body measurement of the virtual being. The personality characteristic fields respectively define at least one personality trait of the virtual being.

According to a further aspect of the present invention, a method of using a virtual being database includes a providing step, a collecting step, a combining step and a sending step. In the providing, a database defining a plurality of virtual beings is provided. In the collecting step, network information requests are collected from the plurality of virtual beings. The network information requests correspond to requests for information from a remote computer that is remote to the database and in communication with the database through a computer network. In the combining step, the network information requests are combined into a single combined request. In the sending step, the combined request is sent over the computer network to the remote computer. In this way, a single request is sent, instead of the numerous individual requests that might otherwise be sent.

Further applicability of the present invention will become apparent from a review of the detailed description and accompanying drawings. It should be understood that the description and examples, while indicating preferred embodiments of the present invention, are not intended to limit the scope of the invention, and various changes and modifications within the spirit and scope of the invention will become apparent to those skilled in the art.

### BRIEF DESCRIPTION OF THE DRAWINGS

The present invention will become more fully understood from the detailed description given below, together with the accompanying drawings which are given by way of illustration only, and are not to be construed as limiting the scope of the present invenion.

In the drawings:

FIG. 1 is block diagram of a first embodiment of a computer system according to the present invention;

FIG. 2 is an exemplary virtual being database according to the present invention;

FIG. 3 is an exemplary virtual being database, along with associated errands lists, according to the present invention;

FIG. 4 is a diagram of a combined request for information to be sent out by a virtual being database server computer system according to the present invention;

FIG. 5 is a flowchart showing an exemplary method of building a virtual being database according to the present invention; and

FIG. 6 is a flowchart showing exemplary methods of accessing, by third parties, the data of a virtual being database through the use of access control tags.

### DETAILED DESCRIPTION OF THE PREFERRED EMBODIMENTS

Before starting a description of the Figures, some terms will now be defined.

### Definitions

the present invention: means at least some embodiments of the present invention; references to various feature(s) of the “present invention” throughout this document do not mean that all claimed embodiments or methods include the referenced feature(s).

field: is used in its conventional database technology related sense; a field generically refers to top-level fields, a sub-fields, sub-sub-fields, and fields at any other level of a database hierarchy.

Access: includes, but is not limited to, read-only access and editing access.

Level of access: refers both to the identity of parties who can perform access and to the extent or types of access that the various parties have.

Edit, editing: access that includes the power to add to, remove from and/or revise a database.

Computer network: any type of computer network that is now conventional or may be developed in the future, including but not limited to, the Internet (and associated World Wide Web), intranets, private networks, wireless networks and so on.

Primary user: an entity or entities that have primary control of and responsibility for a VB.

Secondary user: an entity or entities communicate with a VBD, but that do not have primary control of and responsibility for a VB.

To the extent that the definitions provided above are consistent with ordinary, plain and accustomed meanings (as generally evidenced, inter alia, by dictionaries and/or technical lexicons), the above definitions shall be considered supplemental in nature. To the extent that the definitions provided above are inconsistent with ordinary, plain and accustomed meanings (as generally evidenced, inter alia, by dictionaries and/or technical lexicons), the above definitions shall control. If the definitions provided above are broader than the ordinary, plain and accustomed meanings in some aspect, then the above definitions will control at least in relation to their broader aspects.

To the extent that a patentee may act as its own lexicographer under applicable law, it is hereby further directed that all words appearing in the claims section, except for the above defined words, shall take on their ordinary, plain and accustomed meanings (as generally evidenced, inter alia, by dictionaries and/or technical lexicons), and shall not be considered to be specially defined in this specification. Notwithstanding this limitation on the inference of “special definitions,” the specification may be used to evidence the appropriate ordinary, plain and accustomed meanings (as generally evidenced, inter alia, by dictionaries and/or technical lexicons), in the situation where a word or term used in the claims hasmore than one alternative ordinary, plain and accustomed meaning and the specification is helpful in choosing between the alternatives.

### Description

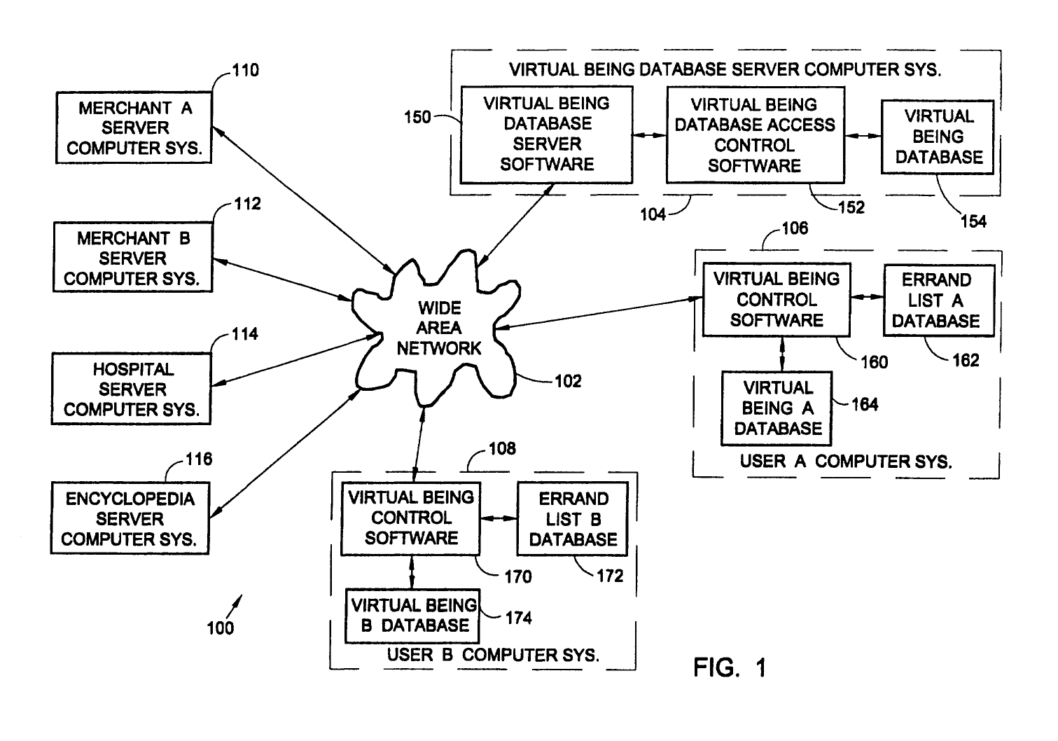

FIG. 1 shows computer system 100 for implementing VBs according to the present invention. Computer system 100 includes wide area network (“WAN”) 102, VBD server computer system 104, user A computer system 106, user B computer system 108, Merchant A server computer system 110, merchant B computer system 112, hospital server computer system 114 and encyclopedia server computer system 116.

WAN 102 is preferably the Internet. Alternatively, other types of computer communication networks now conventional or to be developed in the future may be substituted for or may augment WAN 102. Other types of networks includeintranets, private networks, wireless networks and the like. Whatever the particular network utilized, its purpose is to carry data between the several remote computer systems that make up computer system 100. Because VB data is considered private and sensitive, many or all of the communications should take place over secured channels. The secure channels are preferably made secure in manners now conventional, and which therefore need not be discussed in detail herein. A good rule of thumb is that any communication which would be regarded as sensitive or private should take place over secure channels.

VBD server computer system 104 is the server computer system that hosts a VBD. This VBD is a sort of central repository for VBs in that a multitude of users all over the world hire the provider of VBD server computer system 104 to host their VBs. In this way, the functionality required to set up and administer the VBs can be efficiently centralized and provided to the public for a relatively low price. VBD server computer system 104 is preferably made up of several computers, as is conventional for server computers that host large databases, but server computer system 104 could alternatively be a single computer. Whatever the number and arrangement of individual computer hardware within VBD server computer system 104, the functional modules are VBD server software 150, VBD access control software 152, and VBD 154.

VBD server software 150 is the software that allows VBD server computer system to securely send and receive data over WAN 102. In order to carry out this function, VBD server software includes conventional software, such as firewalls, encryption software and software for setting up secure channel communications. As discussed below, VBD server software 150 facilitates network communications with users and with other third party computers, such as merchant and hospital computers. The users communicate with server computer system 104 in order to set up VBs, assign tasks to their VBs, receive results of assigned tasks from their VBs and edit their VBs when desirable.

VBD access control software 152 is an important feature of the present invention. It controls who accesses the information in the VBD and also controls the specific nature of allowable access, as will be further explained below. Generally speaking, VBD access control software receives request to access some portion of the VBD (as read-only or edit access), and then determines whether the requested access will be allow based on access control data in the VBD.

Of course, in order to determine whether the access control information gives authority to a requestor for access, VBD access control software needs to know the identity of the requester. This can be done by determining the Internet address (domain name or numeric) of the requestor computer, or by having the requestor provide some type of code that is specific to computer system 100. An important advantage of the present invention is that it treats some requestors (such as enumerated trusted parties) more favorably than others (such as uninvited requestors). Even a single requestor may be allowed different levels of access to different parts of the VBD. For example, a hospital (where a VB whose primary user has been a patient and received treatment) may be allowed unfettered access the health related portions of a VB, but denied access to the portions that do not relate to the hospital's work. To summarize, in order to provide the granular access of the VBD of the present invention, it is helpful if those requesting access can be identified in some fashion.

VBD 154 is where the virtual beings, and their associated errands lists (discussed below) are stored. VBD 154 is preferably implemented by off-the-shelf database software, such as Oracle. (The name “Oracle” may be subject to trademark rights.) One important feature of VBD 154 is that its VBs have both body measurement characteristics and personality traits (rather than only one or the other). In this way, the VBs of VBD 154 can more closely emulate both the physical and mental sides of their primary users. Another important feature of VBD 154 is the access control information, because this is how a primary user can determine exactly who gets to see the various portions of its VB.

Also, by controlling editing access, parties other than the primary user, such as secondary users or the VBD server computer system 104 itself can be authorized to make certain types of edits. By allowing others to edit its VB, a user is spared the burden of entering all changes manually. This in turn, can help the VB track the makeup and proclivities of its primary user, because the changes to the VB that others make would often be time-consuming changes that the primary user would be tempted to neglect if he had to manually enter the changes on his own. In addition, certain types of edits, such as addition of or revision to medical history data of the VB may be more appropriately made by trained medical personnel for reasons of accountability and accuracy.

As shown in FIG. 1, user A computer system 106 includes VB control software 160, errand list A database 162 and VB A database 164. Similarly, user B computer system 108 includes VB control software 170, errand list B database 162 and VB B database 164. For clarity of illustration, only two users are shown in this example. Normally, the number of users would be much greater than two. The user computer systems are preferably Internet ready personal desktop or laptop computers, but other types of computers and/or sub-networks of computers are equally possible.

VB control software 160, 170 facilitates communication between the user computers systems and VBD server computer system 104 so that VBs can be contracted for, constructed, utilized and maintained. VB control software 160, 170 respectively include VB builder software for entering VB data to define the VB. This data may be based on the primary user of the VB and may serve as his alter-ego. For example, body measurement data will generally come from measurements made of the primary user's body.

In order to initially create such as alter-ego, the data for the numerous characteristic fields of his VB could come from body measurements, answers to direct and/or indirect queries directed to the primary user about himself, and evaluative tests. For example, if one of the characteristic fields of the VB was typing speed, then the primary user might be given a typing test, so that the result of this typing test could be used to define the VB's typing speed. In this way, if the VB were assigned to go out and search for job opportunities for the primary user, prospective employers could get a reliable indication of typing speed. Having (read-only) access to this VB information, as facilitated by the present invention, may make the prospective employer's computer system (with which the VB is communicating) more inclined to give specific information and/or encouragement to the VB.

Errand database 162 is a list of tasks that the primary user wants to assign to his VB. As discussed below, these task assignments may include reference to specific sources to look for desired information and the specifics of the information sought. For example, the user may assign his VB to go to a hot, new Internet merchant to look for purchase terms for desirable handbags.

The user saves time by utilizing his VB. First, the VB is set up to emulate the primary user and therefore has the same taste in handbags. For this reason, the user doesn't have to spend time entering handbag-related preferences into the hot, new merchant's computer system because the VBD server computer system 104 can do this automatically in his stead, in light of the traits (i.e., favorite color, favorite material, available credit) of the VB seeking handbag availability information. Also, the primary user does not have to deal with (sometimes onerous) aspects of the hot, new merchant's user interface, because the user doesn't visit the merchant, rather, his VB does. This procedure is called unattended shopping.

The VB streamlines the process of collecting relevant information about good and/or services, so that the primary user can focus his attention on the merchant or merchants who seem like the best fit based on the information that the VB has collected. Although the VB may be authorized to actually make purchases on behalf of the primary user, generally consummation of the deal will be left to the primary user. After all, it is far from certain that a VB could ever contain enough fields or be based on sufficiently accurate measurements to be a perfect emulation of the user, at least with respect to subjective judgments. In many embodiments of the present invention, the VB makes the first cut at which information needs to consider in rendering a final decision on some prospective purchase.

Additionally, there is attended shopping mode. The primary user may shop along with his VB, such that the primary user directs the flow of communication, from website to website and within the various websites. By tagging along on the shopping trip, the VB is exposed to additional information about its primary user. This information can be used (if permitted by the access control of the present invention) to cause refinements to the VB itself, so that the VB better emulates the user. This is called automatic tracking.

Virtual being databases 164, 174 are copies of each respective users VB that is stored on the user's own computer system 106, 108. This copy allows the user to enter revisions to its VB, even when the user computer system is not in data communication VBD server computer system 104. The next time a user logs into VBD server computer system, subsequent to a revision to the resident version of its database, the VB in VBD 154 will be correspondingly updated. Alternatively, the users' computer systems do not need to store a complete copies of the respective user's VBs. This saves on storage space.

Third party computer systems 110, 112, 114 and 116 are exemplary of the kind of remote computer systems that the VB might be directed to communicate with over WAN 102. The inclusion of hospital server computer system 114 serves to demonstrate that VBs may be used to explore services, as well as goods. Encyclopedia server computer system 116 is a free encyclopedia, which gives out information without conditions (such as payment) attached. This shows that VBs may be employed for non-commercial, as well as commercial, purposes.

Preferably each of the third parties 110, 112, 114 and 116 that communicates with VDB server computer system 104 is equipped with special software called Interface for Greeting VB (“IGVB”). IGVB is a rule-based expert system software capable of receiving requested tasks from the VBs. IGVB is structured to initiate communication with VBD server computer system 104 by first engaging in a predetermined handshake. For example, the handshake may establish the identity of the IGVB computer, so that the access control software of VBD server computer system will subsequently be able to determine whether the IGVB computer has editing access and/or read-only access to a particular field of a particular VB.

IGVB may reside in a subpage or subdomain of a website, where an unattended shopping request is targeted. After the initiating handshake, data packets may be sent between IGVB and VBD server computer system 104 over a secure connection.

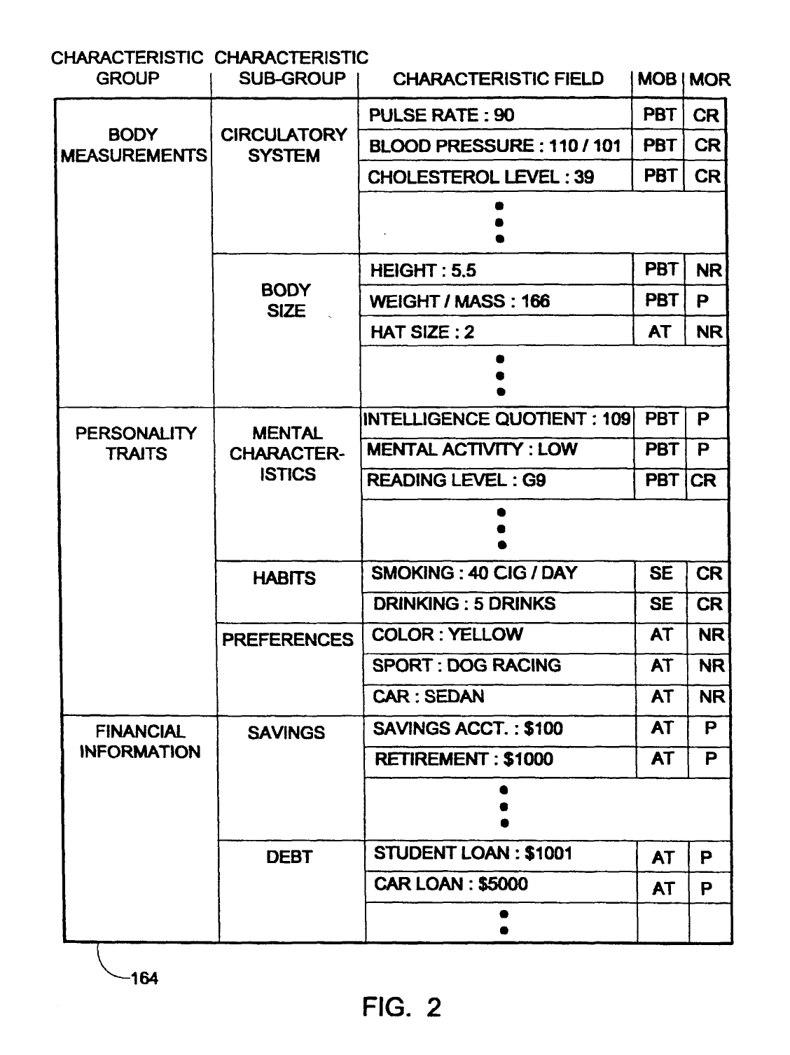

FIG. 2 shows an exemplary VB for user A (stored as VB A database 164). This exemplary VB contains three main groupings of characteristic fields: body measurements, personality traits and financial information. Hierarchically arranged under these three main groupings are various characteristic sub-groups and lowest-level characteristic fields. Further layers may be used to arrange all the desired fields, and it is noted that various portions of the VB do not need to have the same number of layers. One observation about VB 164 is that it combines both body and personality fields into a single VB.

The access control aspects of the present invention are reflected in the mode of building (“MOB”) and mode of release (“MOR”) tags that are associated with each characteristic field in FIG. 2. The MOB tags control editing access with respect to their respectively associated characteristic fields. In other words, the MOB tag determines who can add or change VB information. The MOB tag is structured to allow three values as possible values for editing access of each field.

The three possible values are self entering (“SE”), permission based tracking (“PBT”) and automatic tracking (“AT”). A SE tagged field is protected from revision by all secondary users. The primary user alone sets and revises the information in an SE field. Under the PBT mode of building, trusted secondary users, or groups of secondary users, are additionally allowed editing access to some particular field. Under the AT mode of building, VBD server computer system 104 is permitted to revise the VB's field based on observed interaction. For example, if the primary user is observed to buy lots of yellow colored items, then the primary user's favorite color may be changed to yellow automatically. This saves the user the time and effort of having to make the change manually. Alternatively, there could be more or fewer than three levels of permitted MOB editing access.

Great care should be taken so that MOB editing access according to the present invention does not lead to opportunities for unauthorized users (or hackers) to devise ways to get editing access to a VB and change its data. For example, a hacker may send communications to the VBD server computer system 104 that are structured as if they come from an authorized computer, but, in fact do not. One way to help prevent this is to implement password protection in conjunction with any editing activity. Another way security measure would be to encrypt or encode the VBD so that it is impossible to distinguish access fields from characteristic fields without proper decoding or decrypting. Such encryption and/or encoding can also help prevent unauthorized read-only access by hackers as well.

The MOR tags control read-only access with respect to their respectively associated characteristic fields. In other words, the MOR tag determines who can see the various fields of VB information. The MOR tag is structured to allow three values as possible values for editing access of each field.

The three possible values are no restriction (“NR”), conditional restriction (“CR”) and private (“P”). An NR tagged field is allowed to be seen by all secondary users who request to see the characteristic field. Under the CR mode of release, conditions are attached to read-only access to the tagged field. For example, read-only access may be allowed, if the requestor is a family member. In this way, one spouse could access the other spouses VB in order to buy a gift. Under the P mode of building, nobody is allowed to see the information except the primary user. Alternatively, there could be more or fewer than three levels of permitted MOB editing access.

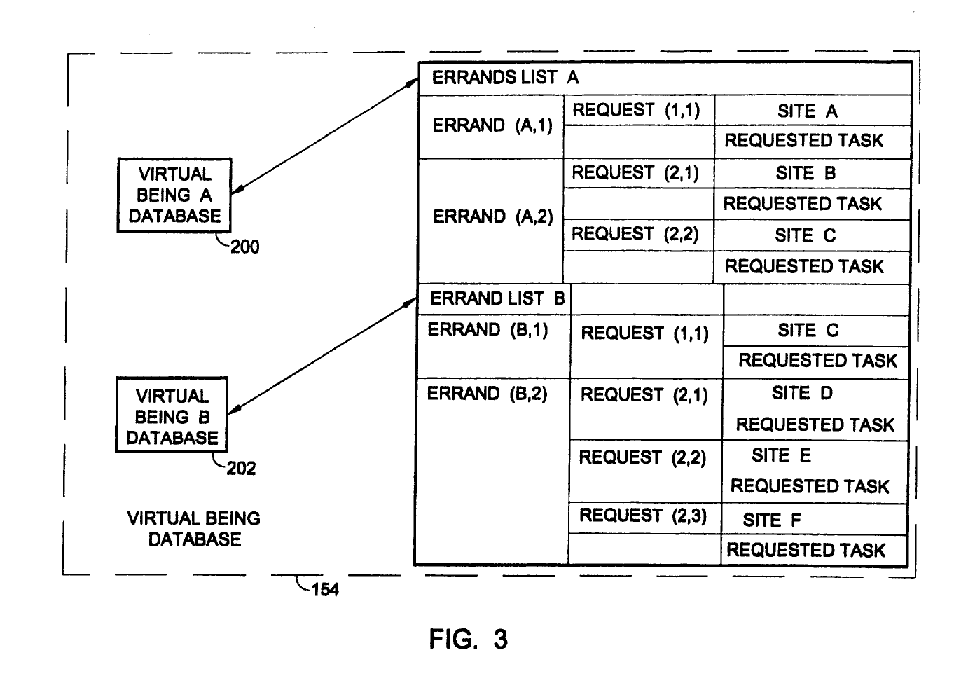

FIG. 3 shows a detailed schematic of virtual database 154. Virtual database 154 includes VB A database 200 and VB B database 202. As shown in FIG. 3, each user's VBD is associated with an errands list. Each errands list is made up of requests. Each request includes a site identifier (site a, site b, site c and so on) and a requested task. Generally, the site identifiers will be chosen by the computer, but it may be possible for a VB to identify specific sites and/or to search for specific sites based on the nature of the requested task and the VB itself.

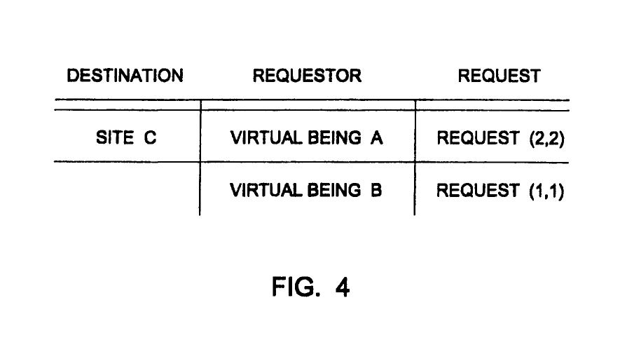

FIG. 4 shows the combined request feature of the present invention. Specifically, as shown in FIG. 3, both users A and B have a requested task to be performed at site c. Perhaps both of these users want information on the handbags being sold by a hot, new Internet merchant. Based on this commonality, VBD server computer system 104 combines these two requests into a single request as shown in FIG. 4. By using combination requests, VBD server computer system 104 will avoid having to send two, separate requests to the hot, new merchant. This improves efficiency of communication.

While this may not seem too necessary when dealing with a mere two requests, it should be kept in mind that VBD server computer system 104 preferably serves a multitude of users. In that setting, agglomerated requests could take the place of hundreds or thousands of separate requests. This is similar to compression techniques conventionally used in connection with large data files, such as audio or video data files. More particularly, the combined request can be sent so that only difference among the individual constituent requests are communicated from the VBD server computer system 104 to a third party IGVB as data.

The IGVB is programmed to recognize a combined request of this type and to reconstruct the individual constituent requests based on the “compressed” differences data. Alternatively, the combine request may not be reconstructed into individual requests at the IGVB, but rather may be responded to by the IGVB as a group. This may happen when a certain product is in high demand and the same requests are frequently repeated by a large group of diverse VBs. To make this example more specific, suppose a team's t-shirts are in high demand before a big game. The intelligent pooling software of VBD server computer system 104 that forms combined requests can calculate the quantity for each different size of the t-shirt, and will send a combined request to the participating site. Once the results are sent back by the IGVB of the participating site, they can be assigned to the requesting VBs on a first-come first serve basis, on a highest bidder basis, or on some other basis.

In order to conserve bandwidth usage for sending redundant or similar requests to all third parties, VBD server computer system 104 may, based on the form and information provided by each participating site, and based on updated information received from a periodic general information query between VBD server computer system 104 and a particular participating site, create a virtual or mirrored IGVB for the participating site within the VBD server computer system itself. In this way, certain communication tasks, such as initial screening and handshake can be performed using the virtual IGVB, rather than sending communications over WAN 102 to the remote IGVB at the remote, participating site.

For example, before Valentine's Day, a site selling flowers will be in demand. Instead of jamming the server of this site with individual requests on an ongoing basis, the VBD server computer system may set up a higher level periodic check with the flower merchant to obtain a current inventory and pricing on roses. In this way, when VBs send individual requests, VBD server computer system 104 can report back with information obtained during the high level monitoring, and the number of remote communications (and attendant bandwidth) will be reduced.

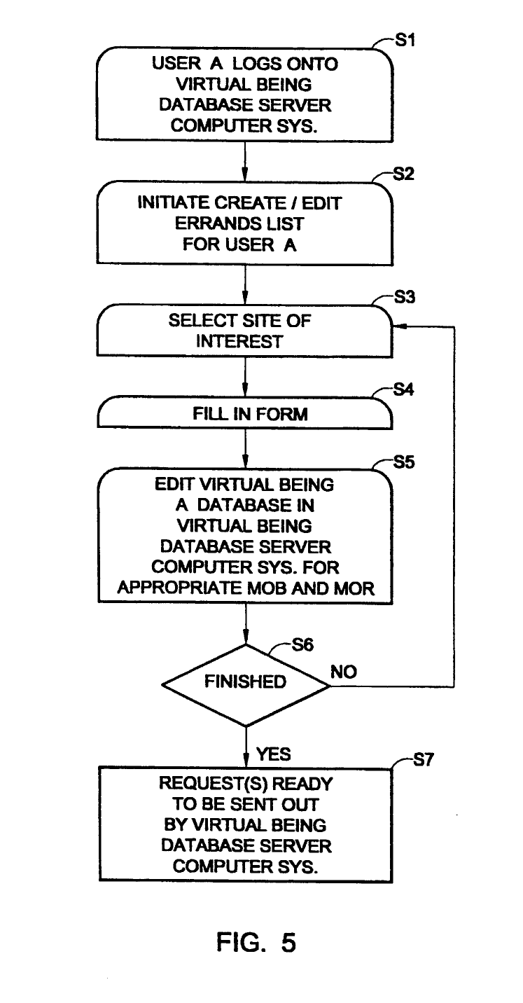

FIG. 5 is a flowchart showing exemplary process flow by which a primary user requests its VB to do errands. Processing proceeds from step S1 of FIG. 5 to step S7 of FIG. 5, except that the decision block at S6 permits the user to request more than one errand. Preferably, the primary user will request a list of errands, in order to provide his VB with a full day's productive work. It is noted that an opportunity to edit the MOB and MOR tags is provided at step S5.

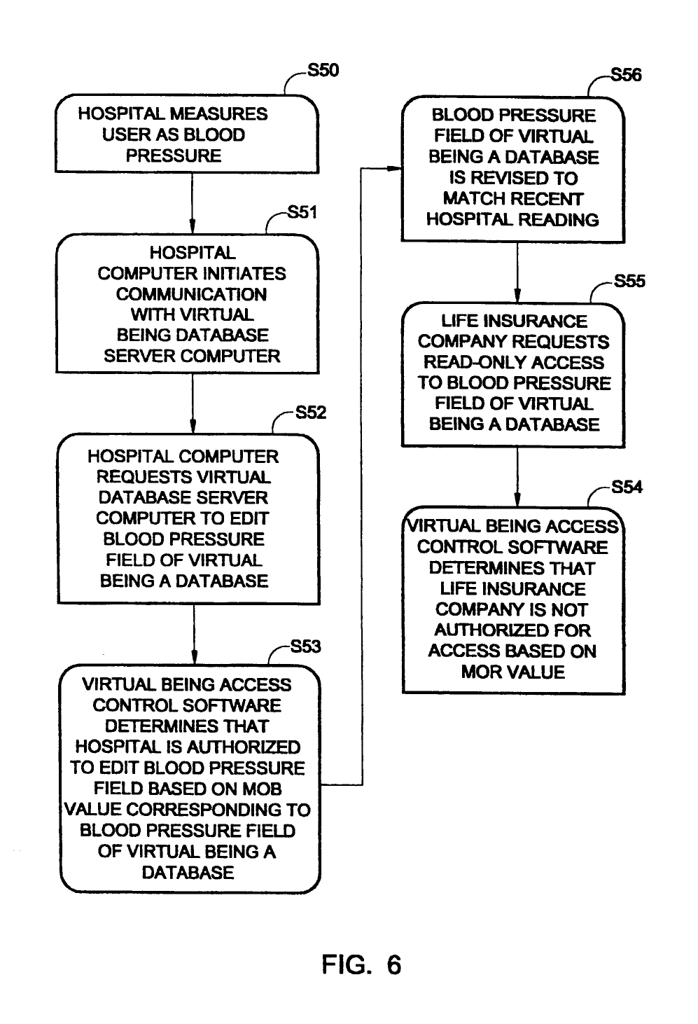

FIG. 6 is a flowchart that show process flow by which hospital server computer system 114 (see FIG. 1) excercises its editing access to the health related fields of of a VB stored in VBD 154. Process flow proceeds from step S50 through step S56. The access control software and MOB tags of the present invention make it possible for this trusted third party to edit portions of the database, which the hospital is better qualified to ascribe than even the primary user himself. However, without a way of determining which characteristic fields can be edited and what trusted parties can do the editing, most primary users would be uncomfortable with allowing any edits to their database by secondary users, such as the hospital.

As the number of VBs increases, it may become cost effective to bring advertising or applications to a group of VBs who share the same interests and/or fit a demographic profile of a likely customer. Preferably, the advertising should be targeted without improper access of private characteristic fields of the various VBs.

As one application for the above-described computers system, the VBs may participate in auctions, reverse auctions, competitive bidding and the like. These auction activities may even be unattended. This is an especially advantageous application of the present invention, because monitoring auction current bids and associated deadlines can be quite time-consuming for a primary user to perform manually, and a virtual being can be given specific instructions regarding how high to bid.

Many variations on the above-described VBDs are possible. Such variations are not to be regarded as a departure from the spirit and scope of the invention, but rather as modifications intended to be encompassed within the scope of the following claims, to the fullest extent allowed by applicable law.

What is claimed is:

1. A virtual being database (154, 164, 174) comprising:
a plurality of characteristic fields (154), with each characteristic field comprising machine readable virtual being data defining at least one characteristic of the virtual being;
access control data (154) comprising machine readable information for controlling access to the virtual being data.

2. The database of claim 1 wherein:
the access control data comprises a plurality of access control fields; and
each characteristic field corresponds to at least one access control field so that access to each characteristic field is controlled by its at least one corresponding access control field.

3. The database of claim 2 wherein the at least one access control field is an editing control field for controlling editing access to the corresponding characteristic field.

4. The database of claim 3 wherein a selection of at least three different values may be selected for allowing at least three different levels of access to the corresponding characteristic.

5. The database of claim 4 wherein possible values for the editing control field are:
self-entering, so that only a primary user of the virtual being can edit the corresponding characteristic field;
permission based tracking, so that only authorized parties can edit the corresponding characteristic field;
automatic tracking, so that the virtual being database can edit the corresponding characteristic field based on observed patterns of interaction.

6. The database of claim 3 wherein:
each characteristic field corresponds to at one additional access control field in addition to the editing access control field; and
the additional access control field is a read-only control field for controlling read-only access to the corresponding characteristic field.

7. The database of claim 6 wherein a selection of at least three different values may be selected for allowing at least three different levels of access to the corresponding characteristic.

8. The database of claim 1 wherein the characteristic fields and access control data are stored in an encrypted and/or encoded manner so that they cannot be the characteristic fields and the access control data cannot be found without decryption and/or decoding.

9. The database of claim 1, further comprising database control software comprising machine readable instructions for receiving an access request and for controlling access to the virtual being data according to the received request and the access control data.

10. The database of claim 9 wherein the database control software further comprises machine readable instructions for receiving a remote access request from a remote computer in communication with the database control software over a computer network and for controlling access to the virtual being data according to the received remote request and the access control data.

11. The database of claim 9 wherein the database control software further comprises machine readable editing request instructions for receiving an editing access request for editing access and for controlling editing access to the virtual being data according to the received editing access request and the access control data.

12. The database of claim 11 wherein the editing request instructions are programmed to receive editing instructions from at least a primary user and from a secondary user which is different than the primary user.

13. The database of claim 12 wherein the secondary user is a medical establishment.

14. The database of claim 11 wherein the database control software further comprises machine readable read-only access instructions for receiving a read-only access request for read-only access and for controlling read-only access to the virtual being data according to the received read-only access request and the access control data.

15. A virtual being database (154, 164, 174) comprising:
a plurality of body measurement characteristic fields (154), with each body measurement characteristic field comprising machine readable virtual being data defining at least one body measurement of the virtual being; and
a plurality of personality characteristic fields (154), with each personality characteristic field comprising machine readable virtual being data defining at least one personality trait of the virtual being.

16. The virtual being of claim 15 wherein the plurality of personality characteristic fields comprise a field defining at least one of the following personality traits: habits, mental agility, intelligence, reading level and personal preferences.

17. A method of using a virtual being database comprising the steps of:
providing a database (154, 164, 174) comprising machine readable data defining a plurality of virtual beings;
collecting, from at least a plurality of the virtual beings, individual requests (204) comprising machine readable data corresponding to requests for information from a remote computer (106, 108) that is remote to the database and in communication with the database through a computer network (102);
combining a plurality of individual requests into a single combined request (FIG. 4); and
sending the combined request over the computer network to the remote computer.

18. The method of claim 17 wherein the remote computer is a merchant server computer system programmed to sell goods and/or services over the computer network.

19. The method of claim 17 further comprising the step of responding, by the remote computer, to the combined request by sending a response communication comprising appropriate responsive information to the combined request back to the virtual being database over the computer network.

20. The method of claim 19 further comprising the step of distributing information from the response communication among the plurality of virtual beings based on the identity of the virtual beings from whom individual requests were collected at the collecting step.

21. A computer system comprising:
a computer network (102);
a server computer (104) comprising a virtual being database (154), the virtual being database comprising machine readable data corresponding to a plurality of virtual beings; and
a plurality of remote merchant computers (110, 112, 114, 116) programmed to sell goods and/or services over the computer network;
wherein the server computer further comprises a plurality of virtual being interface software modules, with each virtual being software module corresponding to one of the plurality of remote merchant computers and serving as an interface between the virtual being database and the remote merchant computer.
